(19) United States
(12) Patent Application Publication
(10) Pub. No.: US 2005/0036307 A1
(43) Pub. Date: Feb. 17, 2005

(54) Flashlight able to emit forceful light

(76) Inventor: Kuo-Tsai Wang, Yun Kan City (TW)

Correspondence Address: PRO-TECHTOR INTERNATIONAL, 20775 Norada Court, Saratoga, CA, 95070-3018, US

(21) Appl. No.: 10/640,741

(22) Filed: Aug. 13, 2003

(51) Int. Cl. F21L 2/00

(52) U.S. Cl. 362/157

(57) ABSTRACT

A flashlight able to emit forceful light includes a lamp base having plural LED lamps at the front side and an anode disc and a cathode ring on the rear side, a light-concentrating base having plural sleeves on the rear side for receiving the LED lamps, an O-shaped ring fitted on the light-concentrating base, a light-focusing lens fitted on the light-concentrating base, a battery holder having three battery grooves separated in parallel and having a cathode conducting member, a front cover having an anode disc and a cathode ring on the front side and a series conducting member and an anode conducting member on the rear side, a rear cover having a series conducting member and a cathode spring on the front side and a cathode disc and a cathode ring on the rear side, and a press switch fitted in a bottom base.

### BACKGROUND OF THE INVENTION

1. Field of the Invention

This invention relates to a flashlight able to emit forceful light, particularly to one having the batteries separately positioned in parallel and conducted in series, able to shorten the length of a flashlight and focus the light of several LED lamps to enable the flashlight to emit powerful light.

2. Description of the Prior Art

A conventional flashlight employs a tungsten filament lamp as a light emitter, as shown in FIG. 8, but the tungsten filament lamp cannot emit forceful light for use. For the present, LED lamps have taken the place of tungsten filament lamps in order to strengthen the light of a flashlight, but the electric source of the LED lamps is of high voltage and low current; therefore only when more than 4.5 volts are supplied can the LED lamp emit forceful light. A common battery contains only 1.5 volts so three batteries (4.5 volts) have to be provided for a flashlight to emit forceful and durable light. Generally, a conventional flashlight has its three batteries positioned linearly and conducted in series, not only lengthening the body of a flashlight but also resulting in inconvenience in storing and carrying of the flashlight. Besides, the large arc-shaped reflector and the thin lens of a conventional flashlight can hardly concentrate and focus the light emitted by its LED lamp, always forming an astigmatic condition.

### SUMMARY OF THE INVENTION

The objective of the invention is to offer a flashlight able to emit forceful light. The flashlight includes a casing, a lamp base, a light-concentrating base, an O-shaped ring, a light-focusing lens, a battery holder, a front cover, a rear cover and a press switch combined together.

The casing is composed of a metallic lampshade, a tube body and a bottom cover screwed together.

The lamp base to be fitted in the lampshade is provided with four LED lamps in the front portion and an anode disc and a cathode ring in the rear portion, having an anode spring fixed on the anode disc.

The light-concentrating base to be fitted at the front side of the lamp base and positioned in the lampshade is provided at the rear side with four sleeves respectively having a conical hole formed in the interior, and each conical hole has its inner diameter growing larger and larger from a rear opening to a front opening.

The O-shaped ring is fitted on the front circumferential edge of the light-concentrating base.

The light-focusing lens covered on the O-shaped ring and the light-concentrating base and firmly fitted in the lampshade is provided with four convex lenses at the rear side to be respectively fitted in the front openings of the four conical holes of the light-concentrating base.

The battery holder to be positioned in the tube body has three battery grooves separated in parallel and a cathode conducting member fitted in an upper portion. The cathode conducting member is composed of a tension spring, two contact needles, two compression springs and two spring sleeves. The tension spring has its opposite ends respectively and orderly fitted therein with the contact needle, the compression spring and the spring sleeve. The two contact needles are pushed to extend out of the battery holder and respectively pass through the front and the rear cover to contact with the cathode ring of the lamp base and the front side of the bottom cover.

The front cover to be secured at the front side of the battery holder has its front side provided with an anode disc and a cathode ring, and its rear side fixed with a series conducting member and an anode conducting member. The anode conducting member is connected with the anode disc. The anode disc and the cathode ring of the front cover respectively match with the anode disc and the cathode ring of the lamp base. The anode disc of the front cover contact closely with the anode spring on the anode disc of the lamp base.

The rear cover to be secured on the rear side of the battery holder has its front side fixed with a series conducting member and a cathode spring, and its rear side provided with a cathode disc and a cathode ring. The cathode spring is connected with the cathode disc, which is connected with one pin of the press switch.

The press switch is fitted in the bottom cover and fixed therein by a positioning tube. The press switch has one pin connected with the cathode disc of the rear cover and the other adapter connected with the bottom cover, able to carry out changeover of cathode interruption and connection.

In assembling, after the front and the rear cover are respectively fixed at the front side and the rear side of the battery holder and three batteries are respectively put in the three battery grooves, the battery holder is received in the tube body. Then, the series conducting member of the front and the rear cover are respectively connected in series with the three batteries, with the anode of the batteries connected with the anode spring of the lamp base and the cathode connected with one pin of the press switch. The press switch has the other pin connected with the cathode ring of the lamp base via the bottom cover and the cathode conducting member of the battery holder. The press switch carries out change-over to turn on and out the four LED lamps, and the light emitted by the four LED lamps is concentrated by the four sleeves of the light-concentrating base and then focused by the light-focusing lens, able to emit forceful and durable light.

Another embodiment of a flashlight able to emit forceful light in the present invention has two battery holders provided between the front and the rear cover. The two battery holders have the tension spring of their cathode conducting member lengthened and have six batteries received in the battery grooves, and then the two battery holders are fitted in a lengthened tube body. Thus, the six batteries have their electric force reinforced up to 9 volts, but the LED lamp is easy to produce high temperature and burn out in case more than 6 volts are supplied. Therefore, a resistance of ¼ watt has to be additionally provided to one pin of the press switch for modulating current and lowering voltage, enabling the flashlight to emit forceful and durable light.

### BRIEF DESCRIPTION OF DRAWINGS

This invention will be better understood by referring to the accompanying drawings, wherein:

FIG. 1 is an exploded perspective view of a first preferred embodiment of a flashlight able to emit forceful light in the present invention:

FIG. 2 is a cross-sectional view of the first preferred embodiment of a flashlight able to emit forceful light in the present invention:

FIG. 3 is a rear view of the first preferred embodiment of a lamp base of a flashlight able to emit forceful light in the present invention:

FIG. 4 is a side-section a 1 view of the first preferred embodiment of a light-concentrating lens of a flashlight able to emit forceful light in the present invention:

FIG. 5 is a rear view of the first preferred embodiment of a front cover of a flashlight able to emit forceful light in the present invention:

FIG. 6 is a front view of the first preferred embodiment of the rear cover of a flashlight able to emit forceful light in the present invention:

FIG. 7 is an exploded perspective view of a second preferred embodiment of a flashlight able to emit forceful light in the present invention: and

FIG. 8 is a front view of a conventional tungsten filament lamp.

### DETAILED DESCRIPTION OF THE PREFERRED EMBODIMENT

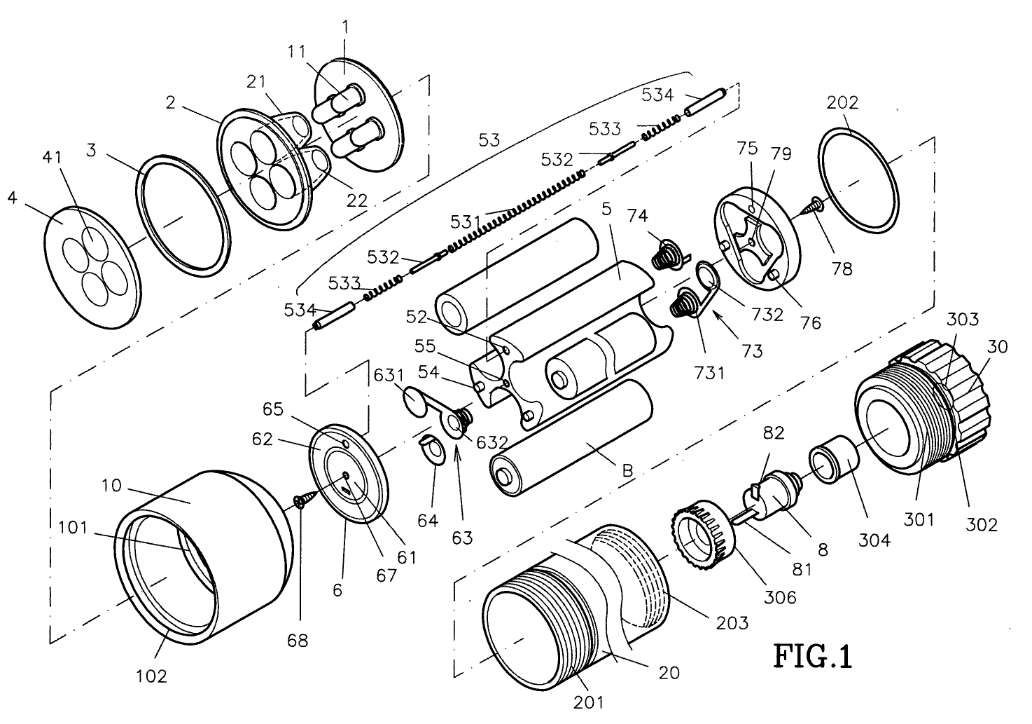

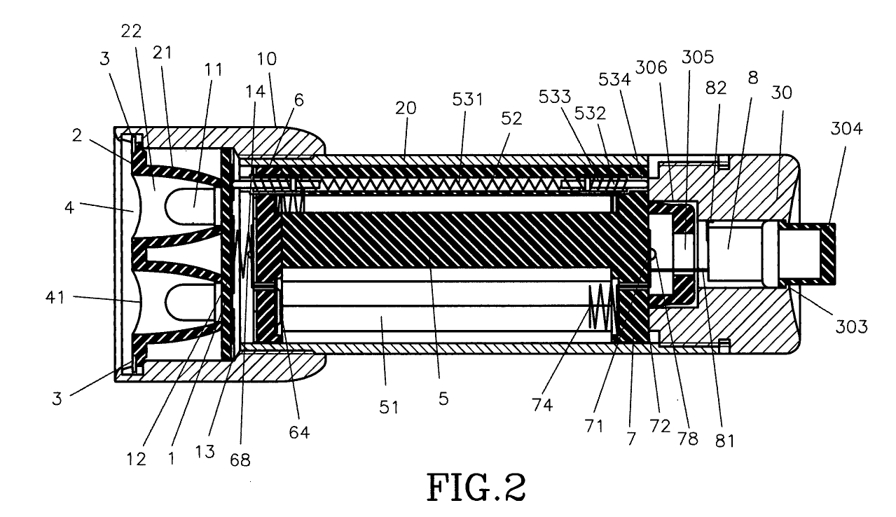

A first preferred embodiment of a flashlight able to emit forceful light in the present invention, as shown in FIGS. 1 and 2, includes a metallic lamp shade 10, a tube body 20, a bottom cover 30, a lamp base 1, a light-concentrating base 2, an O-shaped ring 3, a light-focusing lens 4, a battery holder 5, a front cover 6, a rear cover 7 and a press switch 8 combined together.

The lampshade 10 is formed with female threads 101 around the rear end to be screwed with the tube body 20, and a bent-in engage edge 102 at the front end. The lamp base 1, the light-concentrating base 2 and the O-shaped ring 3 are orderly fitted in the interior of the lampshade 10 and fixed in position by the light-focusing lens 4, which is forcefully pressed in the lampshade 10 through the engage edge 102.

The tube body 20 to receive therein the battery holder 5 and the front and the rear cover 6 and 7, having its front end formed with male threads 201 and fitted with an O-shaped ring 202 to be screwed with the lampshade 10. The tube body 20 is further formed with female threads 203 in the rear end to be screwed with the bottom cover 30.

The bottom base 30 has its front portion formed with male threads 301 and fitted with an O-shaped ring 302 to be screwed with the female threads 203 of the tube body 20, and its rear portion bored with a center hole 303. A waterproof sleeve 304 and the press switch 8 are orderly fitted in the center hole 303 of the bottom cover 30 and a positioning tube 306 having a center hole 305 is also fitted in the front portion of the bottom cover 30, fixing the press switch 8 in position. The press button of the press switch 8 together with the waterproof sleeve 304 extends partly out of the center hole 303 of the bottom cover 30 for facilitating changeover of pressing.

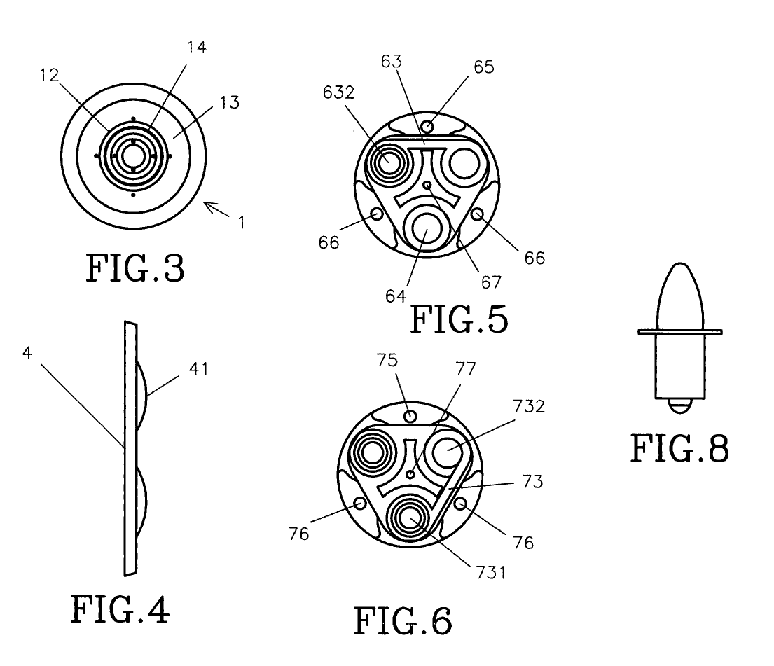

The lamp base 1, as shown in FIGS. 1 and 3, is provided with four LED lamps 11 on the front side and a circuit board with an anode disc 12 and a cathode ring 13 on the rear side. The two pins of each LED lamp 11 are respectively inserted through the lamp base 1 and connected with the anode loop 12 and the cathode ring 13. The anode loop 12 has an anode spring 14 fixed thereon to push and connect to an anode disc 61 of the front cover 6, while the cathode ring 13 is to contact and connect to a contact needle 532 in the cathode conducting member 53 of the battery base 5.

The light-concentrating base 2 to be fitted at the front side of the lamp base 1 is provided at the rear side with four sleeves 21 respectively having a conical hole 22 formed in the interior for the four LED lamps 11 of the lamp base 1 to be fitted therein. The inner diameter of each conical hole 22 grows larger and larger from a rear opening to a front opening, and the four conical holes 22 have their front openings respectively receiving the four convex lenses 41 of the light-focusing lens 4.

The O-shaped ring 3 is fitted around the front circumferential edge of the light-concentrating base 2. When the light-focusing lens 4 is forcefully pressed in the engage edge 102 of the lampshade 10, the O-shaped ring 3 has its elastic body pushing closely against both the light-concentrating base 2 and the light-focusing lens 4 to reinforce stability.

The light-focusing lens 4 to be fitted at the front side of the O-shaped ring 3 and the light-concentrating base 2 is provided with four convex lens 41 on the rear side to be respectively fitted in the front openings of the four conical holes 22 of the light-concentrating base 2, as shown in FIG. 4.

The battery holder 5 is formed with three arc-shaped battery grooves 51 separated in parallel for receiving three batteries (B) therein. The battery base 5 is bored with a through hole 52 in a front section for receiving a cathode conducting member 53. The cathode conducting member 53 is composed of a tension spring 531, two contact needles 532 respectively formed with a propping disc around the intermediate portion, two compression springs 533 and two spring sleeves 534 respectively having a through hole. The tension spring 531 has its opposite ends respectively fitted therein with the contact needle 532, the compression spring 533 and the spring sleeve 534. The two contact needles 532 are pushed by the tension spring 531 to extend out of the battery holder 5 respectively through the through hole of the spring sleeve 534. Then, the two contact needles 532 are respectively inserted through the front and the rear cover 6 and 7 to contact with the cathode ring 13 of the lamp base 1 and the front side of the bottom cover 30. The battery holder 5 has its front end surface provided with two fitting projections 54 at the lower opposite sides of the through hole 52 and bored with a threaded hole 55 in the center for combining the front cover 6.

Further, the battery base 5 has its rear side formed with two fitting slots 56 at the lower opposite sides of the through hole 52 and bored with a threaded hole 57 in the center for combining the rear cover 7.

The front cover 6 to be fixed at the front side of the battery holder 5 has its front side provided with a circuit board with an anode disc 61 and a cathode ring 62 and its rear side fixed with a series conducting member 63 and an anode conducting member 64. The anode conducting member 64 is inserted through the front cover 6 to connect to the anode disc 61. The anode disc 61 and the cathode ring 62 of the front cover 6 respectively match with the anode disc 12 and the cathode ring 13 of the lamp base 1. The anode disc 61 of the front cover 6 contacts closely with the anode spring 14 on the anode disc 12 of the lamp base 1. The series conducting member 63 is formed integral, having one end formed with a conducting disc 631 and the other end formed with a conducting spring 632. The series conducting member 63 of the front cover 6 and the series conducting member 73 of the rear cover 7 together connect the three batteries (B) in series. The front cover 6 is bored in an upper portion with an insert hole 65 smaller in diameter than the through hole 52 of the battery holder 5 for the front contact needle 532 of the cathode conducting member 53 of the battery holder 5 to insert therethrough. Besides, the front cover 6 has two fitting slots 66 bored in the lower opposite sides of the insert hole 65 of its rear side and an insert hole 67 in the center, with a screw 68 inserted through the insert hole 67 to fix the front cover 6 at the front side of the battery holder 5.

The rear cover 7 to be fixed at the rear side of the battery holder 5 has its front side fixed with the series conducting member 73 and a cathode conducting spring 74 and its rear side provided with a circuit board with a cathode disc 71 and a cathode ring 72. The cathode spring 74 is inserted through the rear cover 7 to connect the cathode loop 71, which is connected with the pin 81 of the press switch 8. The series conducting member 73 is formed integral, having one end formed with a conducting spring 731 and the other end formed with a conducting disc 732. The series conducting member 73 of the rear cover 7 and the series conducting member 63 of the front cover 6 together connect the three batteries (B) in series. The rear cover 7 is bored in an upper portion with an insert hole 75 smaller in diameter than the through hole 52 of the battery holder 5 for the rear contact needle 532 of the cathode conducting member 53 of the battery holder 5 to insert therethrough. Further, the rear cover 7 has two fitting projections 76 respectively provided at the lower opposite sides of the insert hole 75 of it front side and an insert hole 77 in the center, with a screw 78 inserted through the insert hole 77 to fix the rear cover 7 at the rear side of the battery holder 5.

The press switch 8 is fitted in the bottom cover 30 and fixed therein by the positioning tube 306. The press switch 8 has one pin 81 passing through the center hole 305 of the positioning tube 306 and connected with the cathode disc 71 of the rear cover 7 and the other pin 82 connected with the inner circumferential edge of the bottom cover 30. The press switch 8 carries out changeover of cathode interruption or conduction.

In assembling, after the front and the rear cover 6 and 7 are respectively fixed at the front side and the rear side of the battery holder 5 by screw 68 and 78, and the three batteries (B) are respectively put in the three battery grooves 51, with the battery holder 5 fitted in the tube body 3. Then, the series conducting member 63 and 73 of the front and the rear cover 6 and 7 are respectively connected in series with the three batteries (B). The anode conducting member 64 and the anode disc 61 of the front cover 6 are connected with the anode spring 14 and the anode disc 12 of the lamp base 1 to form an anode. The rear cover 7 has the cathode spring 74 connected with the cathode disc 71 and the pin 81 of the press switch 8, and the press switch 8 has the other pin 82 connected with the inner circumferential edge and the front side of the bottom cover 30 and the cathode conducting member 53 of the battery holder 5 and the cathode ring 13 of the lamp base 1 to form a cathode. Thus, the press switch 8 can control the four LED lamps 11 of the lamp base 1 to turn on and out and have the light concentrated by the four sleeves 21 of the light-concentrating base 2 and then focused by the four convex lenses 41 of the light-focusing lens 4, thus able to emit forceful light.

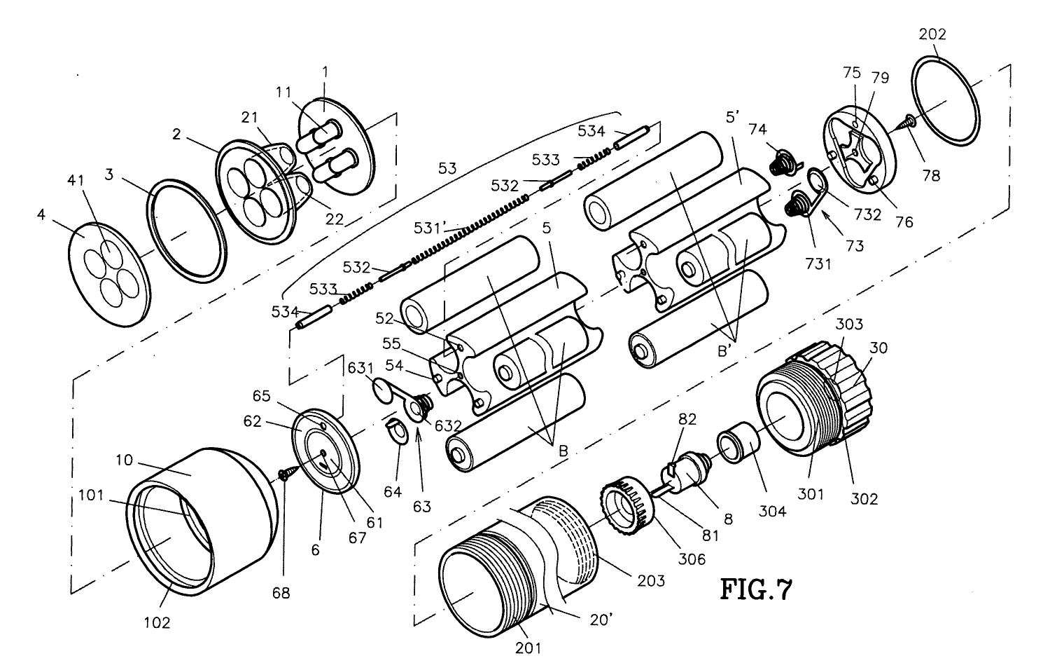

A second preferred embodiment of a flashlight able to emit forceful light in the present invention, as shown in FIG. 7, has the same components as described in the first preferred embodiment, except that two battery holders 5, 5′ are-provided between the front and the rear cover 6 and 7, the tension spring 531 of the battery holder 5 is lengthened into a tension spring 531′, the tube body 2 and the press switch 8 has its pin 81 additionally provided with a resistance 83 for modulating current and lowering voltage.

The battery holder 5 has its front side fixed with the front cover 6, and the battery holder 5′ has its rear side fixed with the rear cover 7. After the two battery holders 5, 5′ have six batteries B, B′, fitted in the battery grooves, they are fitted in a lengthened tube body 20′, thus able to increase electric power and emit forceful light.

While the preferred embodiments of the invention have been described above, it will be recognized and understood that various modifications may be made therein and the appended claims are intended to cover all such modifications that may fall within the spirit and scope of the invention.

1. A flashlight able to emit forceful light comprising:
A casing composed of a lampshade, a tube body and a bottom base screwed together:
A lamp base fitted in said lamp shade, said lamp base installed with plural LED lamps at the front side, said lamp base having its rear side provided with a circuit board with an anode disc and a cathode ring, said anode disc fixed thereon with an anode spring, said anode spring pushing and connecting to the anode disc of a front cover, said cathode ring connecting the cathode conducting member of a battery holder:
A light-concentrating base fitted at the front side of said lamp base and positioned in said lamp shade, said light-concentrating base having its rear side provided with plural sleeves, said& sleeves respectively fitted around said LED lamps of said lamp base for concentrating light:
An O-shaped ring fitted around the front circumferential edge of said light-concentrating base:
A light-focusing lens covered on the front side of said O-shaped ring and said light-concentrating base and positioned in said lamp shade, said light-focusing lens having its rear side provided with plural convex lenses, said convex lenses respectively fitted in the front openings of said sleeves of said light-concentrating base:
A battery holder received in said tube body, said battery holder formed with plural arc-shaped battery grooves, said battery grooves separated in parallel, said battery grooves respectively receiving a battery therein, said battery holder bored with a through hole in an upper portion of a front end surface, said through hole fitted therein with a cathode conducting member, said cathode conducting member having its opposite ends extending out of said battery holder, said cathode conducting member having its opposite ends respectively passing through a front cover and a rear cover and contacting said cathode ring of said lamp base and the front side of said bottom cover, said battery holder having two fitting projections formed on the front end surface and a threaded hole bored in the center, said battery holder having its rear side formed with two fitting slots and bored with a threaded hole in the center:
A front cover fixed at the front side of said battery holder, said front cover having its front side provided with a circuit board with an anode disc and a cathode ring, said front cover having its rear side fixed with a series conducting member and an anode conducting member, said anode conducting member connected with said anode ring, said series conducting member having one end formed with a conducting disc and the other end formed with a conducting spring, said front cover bored with an insert hole at a position facing said through hole of said battery holder, said insert hole of said front cover smaller in diameter than said through hole of said battery holder, said cathode conducting member of said battery holder having one end passing through said insert hole of said front cover, said front cover having two fitting slots at the rear side and an insert hole in the center, a screw inserted through said insert hole of said front cover and said threaded hole of said battery holder to combine them together:
A rear cover secured at the rear side of said battery holder, said rear cover fixed with a series conducting member and a cathode spring on the front side, said rear cover provided with a circuit board with a cathode disc and a cathode ring on the rear side, said cathode spring connected with said cathode ring, said series conducting member having one end formed with a conducting spring and the other end formed with a conducting disc, said series conducting member of said rear cover and said series conducting member of said front cover connecting said batteries in series, said rear cover bored with an insert hole at a position facing said through hole of said battery holder, said insert hole smaller in diameter than said through hole, said cathode conducting member of said battery holder having its rear end passing through said insert hole of said rear cover, said rear cover provided with two fitting projections on the front end surface and an insert hole in the center, a screw inserted through said insert hole of said rear cover and said threaded hole of said battery holder to combine them together; and
A press switch fitted in said bottom cover and fixed therein by a positioning tube, said press switch having one pin passing through the center hole of said positioning tube to connect to said cathode disc of said rear cover, said press switch having the other pin connected with the inner circumferential edge of said bottom cover, said press switch carrying out change-over of cathode interruption or conduction.

2. The flashlight able to emit forceful light as claimed in claim 1, wherein each said sleeve of said light-concentrating base has its interior formed with a conical hole having its inner diameter growing larger and larger from a rear opening to a front opening.

3. The flashlight able to emit forceful light as claimed in claim 1, wherein said cathode conducting member of said battery holder is composed of a tension spring, two contact needles respectively having a propping disc at an intermediate portion, two compression springs and two spring sleeves respectively having a through hole, said tension spring having its opposite ends respectively and orderly fitted therein with said contact needle and said compression spring and said spring sleeve, said two contact needles pushed by said tension spring and respectively having the outer end extending out of said battery holder via said through hole of said spring sleeve, said two contact needles respectively passing through said front and said rear cover to contact said cathode ring of said lamp base and the front side of said bottom cover.

4. The flashlight able to emit forceful light as claimed in claim 1, wherein plural said battery holders of the same structure are provided between said front and said rear cover, and said tension spring of said cathode conducting member of said battery holder is lengthened, said plural battery holders received in a lengthened tube body after their front and rear side are respectively fixed with said front and said rear cover, with a resistance provided on said pin of said press switch for modulating current and lowering voltage.
